(19) United States
(12) Patent Application Publication
(10) Pub. No.: US 2010/0310436 A1
(43) Pub. Date: Dec. 9, 2010

(54) REACTOR AND METHOD FOR THE PRODUCTION THEREOF

(75) Inventors: Ralph Schellen, Dormagen (DE); Evin Hizaler Hoffmann, Koln (DE); Leslaw Mleczko, Dormagen (DE); Stephan Schubert, Leverkusen (DE)

Correspondence Address: Hildebrand, Christa;Norris McLaughlin & Marcus PA, 875 Third Avenue, 8th Floor, New York, NY, 10022, US

(73) Assignee: BAYER TECHNOLOGY SERVICES GMBH, Leverkusen (DE)

(21) Appl. No.: 12/678,838

(22) PCT Filed: Sep. 6, 2008
(86) PCT No.: PCT/EP2008/007297

§ 371 Date: Jul. 15, 2010

(30) Foreign Application Priority Data
Sep. 20, 2007 (DE) 10 2007 045 123.9

(51) Int. Cl. B01J 19/00; B23K 31/02; B23K 1/20

(52) U.S. Cl. 422/198; 228/190

(57) ABSTRACT

A chemical reactor 1 for the reaction of fluid reaction mixtures is disclosed. The reactor includes at least one adiabatic reaction zone 2 with a catalyst bed 3 and at least one heat exchanger 4 downstream of the reaction zone 2. The heat exchanger 4 includes plates 5, 6 which are layered on top of one another and joined to one another. The individual plates 5, 6 have at least two separate fluid flow channels 7, 8 arranged in a predetermined pattern. The plates have fluid flow channels 7, 8 which are arranged so that the reaction mixture flows through the heat exchanger 4 in a first flow path direction and the heat-transfer medium used in the heat exchanger 4 flows through the heat exchanger 4 in a second flow path direction. The plates 5, 6 in the heat exchanger 4 are joined to one another by hard soldering.

The present invention relates to a chemical reactor for the reaction of fluid reaction mixtures. It further relates to a process for producing this reactor and its use.

In the majority of chemical processes, heat either has to be supplied or removed. As a consequence, many parts of chemical plants have the function of accommodating or moving fluids which have to be heated or cooled at particular points in the process. Many chemical processes utilized industrially employ reactors in which the starting materials are reacted in the presence of a catalyst under particular pressure and temperature conditions. Virtually all of the reactions produce or take up heat, i.e. they are exothermic or endothermic. Cooling because of the endothermic reaction generally influences the reaction rate and thus the associated parameters such as conversion and selectivity. Uncontrolled heating due to exothermic reactions generally damages the reaction apparatus. In the case of an uncontrolled temperature rise, i.e. a runaway reaction, undesirable by-products can be formed and the catalyst used can be deactivated. Furthermore, while an ideal catalyst is not altered by the reaction, in reality many catalysts are deactivated or poisoned so that the costs of catalyst regeneration or catalyst replacement represent a considerable cost item on an industrial scale.

WO 01/54806 discloses a reactor having a reaction zone and a heat exchange means of the plate type in operative connection with the reaction zone, in which the heat exchange means is made up of a plurality of metal plates positioned on top of one another. Fluid flow channels are formed in the metal plates according to a predetermined pattern. When being positioned on top of one another, the metal plates are aligned so that discrete heat exchange paths for fluids are defined and connected by means of diffusion welding. However, disadvantages of diffusion welding are that the surface quality of the components to be joined has to meet very demanding requirements in respect of roughness, cleanliness, dimensional accuracy and planarity. The production conditions are also disadvantageous: it is necessary to use a high vacuum and high joining temperatures of up to about 1000° C. and the associated energy consumption, long operating and processing times and restrictions in respect of the base materials and material combinations. The resulting costs of such products can drastically restrict their use. As regards the materials of construction, there is the risk at relatively high temperatures as occur in diffusion welding that the workpiece will become thermally distorted and that the strength of the workpiece will suffer as a result of structural changes.

Alternative joining methods have been discussed in connection with microreactors. Thus, DE 102 51 658 A1 discloses that in order to produce microstructural components, at least one multifunctional barrier layer and a solder layer on top of the at least one barrier layer are applied at least to the surfaces to be joined of microstructured component layers of aluminium and/or aluminium alloys, copper/copper alloys and/or stainless steels, the component layers are stacked and then soldered by application of heat. However, this publication relates to microstructural components.

It can be seen from the above that there continues to be a need for a chemical reactor which is not restricted to the microstructural scale, which can be employed as a multistage adiabatic reactor and can be produced more cheaply and with lower thermal stress than has hitherto been possible when diffusion welding has been used.

The object is achieved according to the present invention by a chemical reactor for the reaction of fluid reaction mixtures, which comprises at least one adiabatic reaction zone comprising a catalyst bed and further comprises at least one heat exchanger downstream of the reaction zone, with the heat exchanger comprising plates which are layered on top of one another and joined to one another, the individual plates having at least two separate fluid flow channels arranged in a predetermined pattern and the plates provided with fluid flow channels being arranged so that the reaction mixture flows through the heat exchanger in a first flow path direction and the heat-transfer medium used in the heat exchanger flows through the heat exchanger in a second flow path direction, wherein the plates in the at least one heat exchanger are joined to one another by hard soldering.

Catalyst beds are present in the reaction zones. For the present purposes, a catalyst bed is an arrangement of the catalyst in all forms known per se, for example as a fixed bed, moving bed or fluidized bed. Preference is given to a fixed-bed arrangement. This includes a catalyst bed in the true sense, i.e loose, supported or unsupported catalyst in any form, or in the form of suitable packings.

The expression catalyst bed as used here also encompasses continuous regions of suitable packings on a support material or structured catalyst supports. These would be, for example, ceramic honeycomb supports to be coated having comparatively high geometric surface areas or corrugated layers of woven wire mesh on which, for example, catalyst granules are immobilized.

The heat exchanger is constructed in such a way that it can be described as a sequence of plates layered on top of one another and connected to one another. Fluid flow channels through which a fluid can flow from one side of a plate to the other side, for example to the opposite side, are worked into the plates. The channels can be linear, i.e. form the shortest possible path. However, they can also form a longer path by having a wave-shape, meandering or zig-zag course. The cross-sectional profile of the channels can be, for example, semicircular, elliptical, square, rectangular, trapezium-shaped or triangular. The presence of at least two separate fluid flow channels per plate means that these channels run through the plate and the fluid flowing therein cannot change between the channels.

The flow path direction can be defined by the vector between the plane in which the starting points of the fluid flow channels are located and the plane in which the end points of the fluid flow channels of a plate or a stack of plates are located. It thus indicates the general direction of the flow of the fluid through the heat exchanger. A first flow path direction indicates the direction in which the process gas mixture flows through the heat exchanger or, as a continuation, through the reaction zone. A second flow path direction indicates the path of the heat-transfer medium. This can, for example, flow in cocurrent, countercurrent or cross-current to the process gas mixture.

Overall, the heat exchanger operates so effectively that the temperature of the process gas mixture does not lead to local overheating of the catalyst when it enters the catalyst bed of the next reaction zone even when reaction occurs.

Joining of the plates in the at least one heat exchanger by means of hard soldering means that by definition a solder having a melting point of ≧450° C. is used. Use of solders having lower melting points is referred to as soft soldering and this results in a lower mechanical strength of the solder bond. For the purposes of the present invention, the upper limit to the melting point of the solder can be ≦900° C., ≦1100° C. or ≦1200° C. Hard soldering is also known as brazing.

Soldering of the plates of the heat exchanger makes it possible to provide a heat exchanger and thus overall a chemical reactor according to the invention with a lower energy input. Suitable choice of a solder also makes it possible to join material combinations of the individual plates which cannot be achieved by means of diffusion welding.

In one embodiment, the material of the plates of the heat exchanger is selected from the group consisting of stainless steel, 1.4571, nickel and/or nickel-based alloys. These materials are suitable for use in the heat exchanger because of their mechanical strength and chemical resistance.

In a further embodiment, the plates of the heat exchanger are joined to one another by means of solder selected from the group consisting of copper-based solder, silver-containing solder, cadmium- and silver-containing solder and/or nickel-based solder. These solders are suitable because of their mechanical strength and chemical resistance.

In a further embodiment, the catalyst bed is configured as structured packing in the reactor. In a further embodiment of the present invention, the catalyst is present as monolithic catalyst in the catalyst bed. The use of structured catalysts such as monoliths, structured packings and also coated catalysts has the main advantage of reducing the pressure drop. Apart from the advantages for the overall process, the volume which has to be introduced for the catalyst in the construction of the reactor and the heat-exchange area can be realized by a lower flow cross section at longer reaction and heat-exchange stages at a lower specific pressure drop. A further advantage of the use of structured catalysts is that shorter diffusion paths of the reactants are necessary in the thinner catalyst layers, which can result in an increase in the catalyst selectivity.

In a structured catalyst bed, the channels introduced can have a hydraulic diameter of from ≧0.1 mm to ≦10 mm, preferably from ≧0.3 mm to ≦5 mm, more preferably from ≧0.5 mm to ≦2 mm. The specific surface area of the catalyst increases when the hydraulic diameter decreases. If the diameter becomes too small, a greater pressure drop arises. Furthermore, it is also possible for a channel to become blocked on impregnation with a catalyst suspension.

In a further embodiment of the present invention, the hydraulic diameter of the fluid flow channels in the heat exchanger is from ≧10 μm to ≦10 mm, preferably from ≧100 μm to ≦5 mm, more preferably from ≧1 mm to ≦2 mm. Particularly effective heat exchange is ensured at these diameters.

In a further embodiment, the reactor has from ≧6 to ≦50, preferably from ≧10 to ≦40, more preferably from ≧20 to ≦30, sequences of reaction zone and heat exchanger. At such a number of reaction zones, the material usage can be optimized in respect of the conversion of reactants. A smaller number of reaction zones would lead to unfavourable temperature conditions. The entry temperature of the reaction mixture would have to be selected to be lower, as a result of which the catalyst would become less active. Furthermore, the average temperature of the reaction then also drops. A larger number would not justify the costs and materials usage because of the small increase in conversion. Handling of corrosive gases such as HCl, O₂ and Cl₂ requires resistant and correspondingly expensive materials for the reactor.

In a further embodiment, the length of at least one reaction zone in the reactor, measured in the flow path direction of the reaction mixture, is from ≧0.01 m to ≦5 m, preferably from ≧0.03 in to ≦1 m, more preferably from ≧0.05 m to ≦0.5 m. The reaction zones can all have the same length or can have different lengths. Thus, for example, the early reaction zones can be short since sufficient starting materials are available and excessive heating of the reaction zone is to be avoided. The late reaction zones can then be long in order to increase the total conversion of the process; here, excessive heating of the reaction zone is less of a problem. The lengths indicated have been found to be advantageous since at shorter lengths the reaction cannot proceed to the desired conversion and in the case of longer lengths the flow resistance for the process gas mixture increases too much. Furthermore, catalyst replacement is more difficult to carry out in the case of greater lengths.

In a further embodiment, the catalyst in the reaction zones in the reactor independently comprises substances selected from the group consisting of copper, potassium, sodium, chromium, cerium, gold, bismuth, iron, ruthenium, osmium, uranium, cobalt, rhodium, iridium, nickel, palladium and/or platinum and also oxides, chlorides and/or oxychlorides of the abovementioned elements. Particularly preferred compounds here include: copper(I) chloride, copper(II) chloride, copper(I) oxide, copper(II) oxide, potassium chloride, sodium chloride, chromium(III) oxide, chromium(IV) oxide, chromium(VI) oxide, bismuth oxide, ruthenium oxide, ruthenium chloride, ruthenium oxychloride and/or rhodium oxide.

The catalyst can be applied to a support. The support component can comprise: titanium oxide, tin oxide, aluminium oxide, zirconium oxide, vanadium oxide, chromium oxide, uranium oxide, silicon oxide, silica, carbon nanotubes or a mixture or compound of the substances mentioned, in particular mixed oxides such as silicon-aluminium oxides. Further particularly preferred support materials are tin oxide and carbon nanotubes.

The supported ruthenium catalysts can, for example, be obtained by impregnation of the support material with aqueous solutions of RuCl₃ and, if appropriate, a promoter for doping. The shaping of the catalyst can be carried out after or preferably before impregnation of the support material.

Suitable promoters for doping the catalysts are alkali metals such as lithium, sodium, rubidium, caesium and in particular potassium, alkaline earth metals such as calcium, strontium, barium and in particular magnesium, rare earth metals such as scandium, yttrium, praseodymium, neodymium and in particular lanthanum and cerium, also cobalt and manganese and mixtures of the abovementioned promoters.

The shaped bodies can subsequently be dried at a temperature of from ≧100° C. to ≦400° C. under a nitrogen, argon or air atmosphere and, if appropriate, calcined. The shaped bodies are preferably firstly dried at from ≧100° C. to ≦150° C. and subsequently calcined at from ≧200° C. to ≦400° C.

In a further embodiment, the particle size of the catalyst in the reactor is independently from ≧1 mm to ≦10 mm, preferably from ≧1.5 mm to ≦8 mm, more preferably from ≧2 mm to ≦5 mm. The particle size can in the case of approximately spherical catalyst particles correspond to the diameter or in the case of approximately cylindrical catalyst particle can correspond to the extension in the longitudinal direction. The particle size ranges mentioned have been found to be advantageous since in the case of smaller particle sizes a greater pressure drop occurs and in the case of larger particles the ratio of the usable particle surface area to the particle volume decreases and the achievable space-time yield thus becomes smaller. The catalysts or supported catalysts can in principle have any shape, for example spheres, rods, Raschig rings or granules or pellets.

In a further embodiment, the catalyst has a different activity in various reaction zones in the reactor, with preference being given to the activity of the catalyst in the reaction zones increasing along the flow path direction of the reaction mixtures. If the concentration of the starting materials in the early reaction stages is high, their reaction and therefore also the temperature of the process gas mixture will increase considerably as a result thereof. It is therefore possible to select a catalyst having a relatively low activity to avoid an undesirable temperature increase in the early reaction zones. An effect of this is that cheaper catalysts can be used. To achieve a very high conversion of the remaining starting materials in late reaction zones, catalysts which are more active can be used there. Overall, the different activities of the catalysts in the individual reaction zones thus makes it possible to keep the temperature of the reaction within a narrower and thus more advantageous temperature range.

An example of a change in the catalyst activity would be if the activity in the first reaction zone were to be 30% of the maximum activity and were to increase in steps of 5%, 10%, 15% or 20% per reaction zone until the activity in the last reaction zone is 100%.

The activity of the catalyst can be set, for example, by the amount of catalytically active compound being different for the same base material of the support, the same promoter and the same catalytically active compound. Furthermore, particles which have no activity can also be mixed in to effect macroscopic dilution.

In a further embodiment, the heat-transfer medium which flows through a heat exchanger in the reactor is selected from the group consisting of liquids, boiling liquids, gases, organic heat-transfer media, salt melts and/or ionic liquids, with preference being given to choosing water, partially vaporizing water and/or steam. For the present purposes, partially vaporizing water means that liquid water and water vapour are present side by side in the individual fluid flow channels of the heat exchanger. This offers the advantages of a high heat transfer coefficient on the side of the heat-transfer medium, a high specific heat uptake due to the enthalpy of vaporization of the heat-transfer medium and a constant temperature of the heat-transfer medium over the channel. Particularly in the case of heat-transfer medium conveyed in cross-current to the reactant flow, the constant vaporization temperature is advantageous since it allows uniform heat removal over all reaction channels. The regulation of the temperature of the reactants can be effected via adjustment of the pressure level and thus the temperature for the vaporization of the heat-transfer medium.

The present invention further provides a process for producing a reactor according to the present invention, in which the production of the heat exchanger comprises the following steps:

a) cleaning of the surface of the lands and the rear sides of the plates to remove oxides and deposits;

b) application of solder to the upper side of the lands;

c) stacking and alignment of the heat exchanger plates to be joined;

d) hard soldering of the stack of plates by application of heat in a furnace.

In an embodiment of the process, a peak-to-valley height of ≦100 μm, preferably ≦25 μm, is achieved in step a).

In a further embodiment of the process, in step b) a protective composition is introduced into the fluid flow channels before application of the solder to the upper side of the lands, with the protective composition being suitable for preventing the intrusion of solder into the fluid flow channels and the protective composition being removed again after application of the solder. The protective composition can line or completely fill the fluid flow channels. The removal of the protective composition can be effected by dissolving out or melting out. The protective composition prevents the solder from blocking the fluid flow channels.

In a further embodiment of the process, the application of heat in step d) takes place in an inert and/or reducing protective gas atmosphere. An example of an inert protective gas atmosphere is argon or nitrogen gas. An example of a reducing protective gas atmosphere is hydrogen gas.

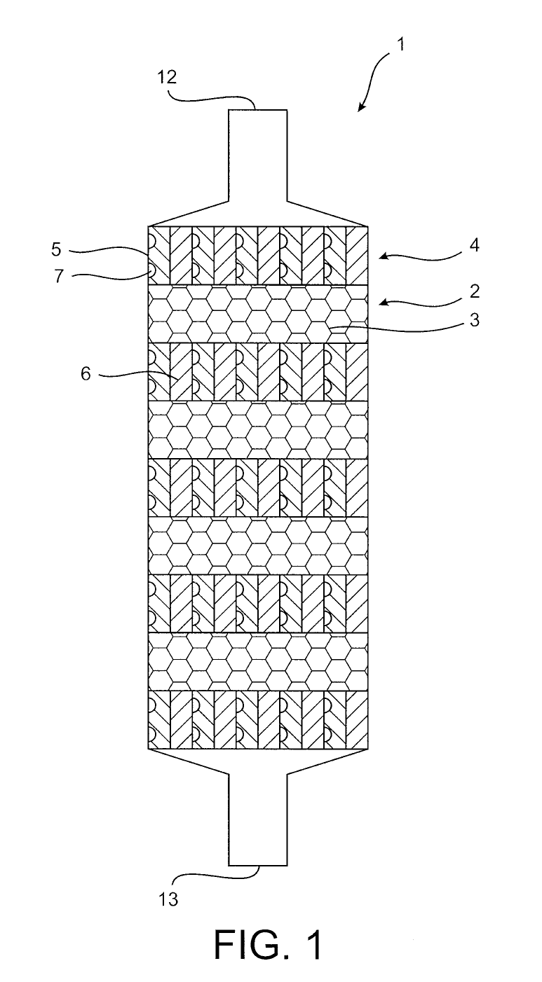

The present invention is illustrated with the aid of FIGS. 1 to 3 without the figures constituting a restriction of the invention. In the figures:

FIG. 1 shows a chemical reactor according to the invention

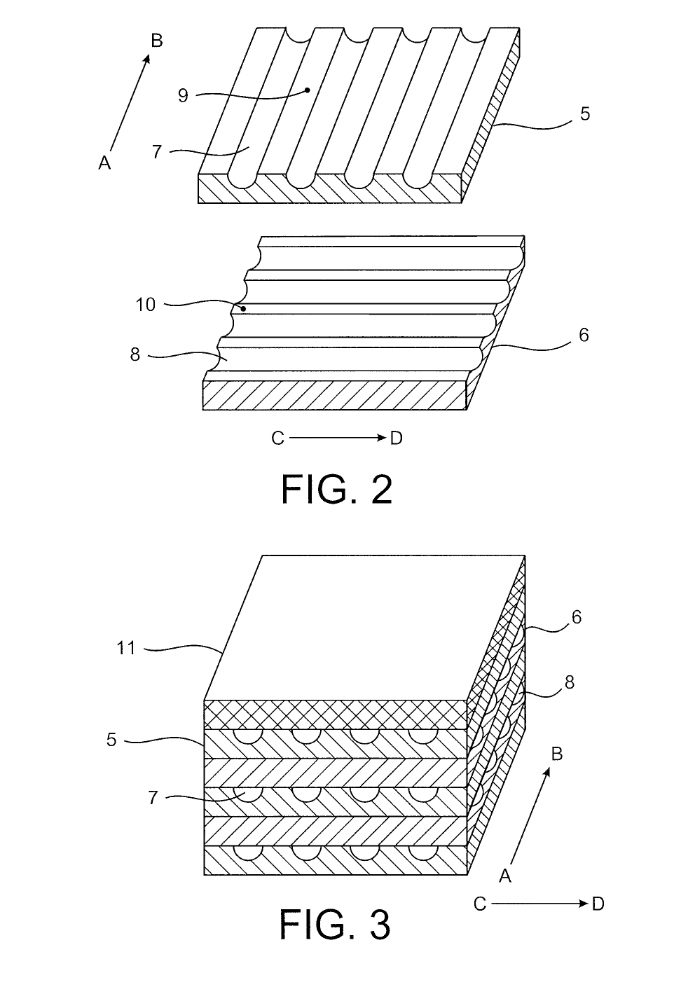

FIG. 2 shows two plates of the heat exchanger

FIG. 3 shows connected plates of the heat exchanger

The reference numerals in the figures have the following meanings:
1 reactor
2 reaction zone
3 catalyst bed
4 heat exchanger
5 plate of the heat exchanger
6 plate of the heat exchanger
7 fluid flow channel
8 fluid flow channel
9 surface of a plate of the heat exchanger
10 surface of a plate of the heat exchanger
11 covering plate
12 inlet for reaction mixture
13 outlet for reaction mixture

FIG. 1 shows a chemical reactor 1 according to the invention. The reactor is suitable for the reaction of fluid reaction mixtures which flow through the reactor. The reaction mixture is introduced into the reactor via the inlet 12. It firstly flows through a heat exchanger 4. This heat exchanger comprises, like the subsequent heat exchangers too, a sequence of pairs of plates 5 and 6. The alternating plates arranged next to each other in rows have fluid flow channels. In the depiction of FIG. 1, fluid flow channel 7 in the first plates 5 are shown in cross section. A heat-transfer medium can flow through these. The fluid flow channels of the second plate 6 run in the direction of the flowing reaction mixtures and are consequently not shown in the depiction of FIG. 1.

After the reaction mixture has flowed through the first heat exchanger and has reached the predetermined temperature, it flows on into a reaction zone 2. This is designed for carrying out an adiabatic reaction. A catalyst bed 3 is depicted in honeycomb form. The reaction mixture leaves the reaction zone and enters the next heat exchanger where it is brought to the desired temperature. This sequence of reaction zone and heat exchanger is repeated until the reaction mixture leaves the reactor again through the outlet 13.

FIG. 2 shows two plates 5 and 6 of the heat exchanger 4. The depiction can be regarded as part of an exploded view of the heat exchanger. The first plate 5 has straight fluid flow channels 7 having a semicircular cross section. The flow path direction, which is prescribed by the fluid flow channels 7, is shown by the drawn-in vector A→B. Lands having a surface 9 are located between the fluid flow channels 7.

The second plate 6 in FIG. 2 likewise has straight fluid flow channels 8 having a semicircular cross section. They run at right angles to the channels 7 of the first plate 5. The flow path direction, which is prescribed by the fluid flow channels 8, is shown by the drawn-in vector C→D. This vector runs at right angles to the vector A→B. Lands having a surface 10 are located between the fluid flow channels 8.

FIG. 3 shows plates 5 and 6 of the heat exchanger 4 which have been joined to one another to form a stack. The plates 5 and 6 are layered alternately on top of one another. The fluid flow channels 7 of the plates 5 define a first flow path direction which is indicated by the vector A→B. The fluid flow channels 8 of the plates 6 define a second flow path direction which is indicated by the vector C→D. Thus, for example, the reaction mixture can flow through the heat exchanger along the first flow path direction and a heat-transfer medium can flow along the second flow path direction. The uppermost plate 5 can be closed off by a covering plate 11. This covering plate can also be part of the housing of the reactor.

1. Chemical reactor (1) for the reaction of fluid reaction mixtures, comprising
at least one adiabatic reaction zone (2) comprising including a catalyst bed (3) and at least one heat exchanger (4) disposed downstream of the at least one adiabatic reaction zone (2),
the heat exchanger (4) comprises individual plates (5, 6) which are layered on top of one another and joined to one another,
the individual plates (5, 6) having at least two separate fluid flow channels (7, 8) arranged in a predetermined pattern,
the plates are provided with fluid flow channels (7, 8) and being arranged so that the reaction mixture flows through the heat exchanger (4) in a first flow path direction and the heat-transfer medium used in the heat exchanger (4) flows through the heat exchanger (4) in a second flow path direction, wherein
the plates (5, 6) in the at least one heat exchanger (4) are joined to one another by hard soldering.

2. Reactor according to claim 1, wherein the material of the plates (5, 6) of the heat exchanger (4) is selected from the group consisting of stainless steel, 1.4571, nickel and/or nickel-based alloys.

3. Reactor according to claim 1, wherein the plates (5, 6) of the heat exchanger (4) are joined to one another by means of solder selected from the group consisting of copper-based solder, silver-containing solder, cadmium- and silver-containing solder and/or nickel-based solder.

4. Reactor according to claim 1, wherein the catalyst bed (3) is configured as structured packing.

5. Reactor according to claim 1, wherein the catalyst is present as monolithic catalyst in the catalyst bed (3).

6. Reactor according to claim 1, wherein the hydraulic diameter of the fluid flow channels (7, 8) in the heat exchanger (4) is from ≧10 μm to ≦10 mm.

7. Reactor according to claim 1, wherein there are from ≧6 to ≦50 sequences of reaction zone (2) and heat exchanger (4).

8. Reactor according to claim 1, wherein the length of at least one reaction zone (2), measured in the flow path direction of the reaction mixture, is from ≧0.01 m to ≦5 m

9. Reactor according to claim 1, wherein the catalyst in the reaction zones (2) independently comprises substances selected from the group consisting of copper, potassium, sodium, chromium, cerium, gold, bismuth, iron, ruthenium, osmium, uranium, cobalt, rhodium, iridium, nickel, palladium and/or platinum and also oxides, chlorides and/or oxychlorides of the abovementioned elements.

10. Reactor according to claim 1, wherein the particle size of the catalyst is independently from ≧1 mm to ≦10 mm.

11. Reactor according to claim 1, wherein the catalyst has a different activity in various reaction zones (2) in the reactor, with preference being given to the activity of the catalyst in the reaction zones (2) increasing along the flow path direction of the reaction mixtures.

12. Reactor according to claim 1, wherein a heat-transfer medium which flows through the heat exchanger (4) is selected from the group consisting of liquids, boiling liquids, gases, organic heat-transfer media, salt melts and/or ionic liquids, with preference being given to choosing water, partially vaporizing water and/or steam.

13. Process for producing a reactor according to claim 1, wherein the production of the heat exchanger comprises the following steps:
a) cleaning of the surface of the lands (9, 10) and the rear sides of plates (5, 6) to remove oxides and deposits;
b) application of solder to the upper side of the lands (9, 10);
c) stacking and alignment of the heat exchanger plates (5, 6) to be joined;
d) hard soldering of the stack of plates by application of heat in a furnace.

14. Process according to claim 13, wherein a peak-to-valley height of ≦100 μm is achieved in step a).

15. Process according to claim 13, wherein, in step b), a protective composition is introduced into the fluid flow channels (7, 8) before application of the solder to the upper side of the lands (9, 10), with the protective composition being suitable for preventing the intrusion of solder into the fluid flow channels (7, 8) and the protective composition being removed again after application of the solder.

16. Process according to claim 13, wherein the application of heat in step d) takes place in an inert and/or reducing protective gas atmosphere.

17. Reactor according to claim 6, wherein the hydraulic diameter of the fluid flow channels (7, 8) in the heat exchanger (4) is from ≧100 μm to ≦5 mm.

18. Reactor according to claim 6, wherein the hydraulic diameter of the fluid flow channels (7, 8) in the heat exchanger (4) is from ≧1 mm to ≦2 mm.

19. Reactor according to claim 7, wherein there are from ≧10 to ≦40 sequences of reaction zone (2) and heat exchanger (4).

20. Reactor according to claim 7, wherein there are from ≧20 to ≦30 sequences of reaction zone (2) and heat exchanger (4).

21. Reactor according to claim 8, wherein the length of at least one reaction zone (2), measured in the flow path direction of the reaction mixture, is from ≧0.03 m to ≦1 m, more preferably from ≧0.05 m to ≦0.5 m.

22. Reactor according to claim 8, wherein the length of at least one reaction zone (2), measured in the flow path direction of the reaction mixture, is from ≧0.05 m to ≦0.5 m.

23. Reactor according to claim 10, wherein the particle size of the catalyst is independently from ≧1.5 mm to ≦8 mm.

24. Reactor according to claim 10, wherein the particle size of the catalyst is independently from ≧2 mm to ≦5 mm.

25. Process according to claim 13, wherein a peak-to-valley height of ≦25 μm is achieved in step a).
